(19) United States
(12) Patent Application Publication
(10) Pub. No.: US 2025/0133629 A1
(43) Pub. Date: Apr. 24, 2025

(54) Activating MBS Transmission and Reception

(71) Applicant: GOOGLE LLC, Mountain View, CA (US)

(72) Inventor: Chih-Hsiang Wu, Taoyuan City (TW)

(21) Appl. No.: 18/681,500

(22) PCT Filed: Aug. 5, 2022
(86) PCT No.: PCT/US2022/039646

§ 371 Date: Feb. 5, 2024

(51) Int. Cl. H04W 76/40; H04W 68/02; H04W 74/0833; H04W 76/27

(52) U.S. Cl. CPC H04W 76/40; H04W 68/02; H04W 74/0833; H04W 76/27

(57) ABSTRACT

To activate reception of multicast and/or broadcast services (MBS), a UE operating in an inactive state of a protocol for controlling radio resources receives, in the inactive state from a radio access network (RAN), a message including an MBS session identifier (ID). The UE initiates reception of MBS data corresponding to the MBS session ID in response to the message.

### FIELD OF THE DISCLOSURE

This disclosure relates to wireless communications and, more particularly, to activating transmission and/or reception of one or more multicast and/or broadcast services (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier, 3GPP has proposed that for Release 17, a 5G NR base station can provide multicast and/or broadcast services (MBS) to UEs that can be useful in many content delivery applications, such as transparent IPv4/IPv6 multicast delivery, IPTV, software delivery over wireless, group communications, IoT applications, V2X applications, and emergency messages related to public safety.

To provide multicast and/or broadcast service (MBS), a base station can configure plural UEs with a common frequency resource (CFR) and a physical downlink control channel (PDCCH) configuration configuring a group common PDCCH. The base station can assign a group common radio network temporary identifier (RNTI) to these UEs to receive physical downlink shared channel (PDSCH) transmissions including MBS data packet(s). Then the base station can send a downlink control information (DCI) with a cyclic redundancy check (CRC) scrambled by the group common RNTI on a group common PDCCH to schedule a PDSCH transmission including MBS data packet(s).

However, it is not clear how a radio access network (RAN) should notify the UE of activation of broadcast services. It is also not clear how the UE distinguish notifications of broadcast services from notifications of multicast services.

### SUMMARY

An example embodiment of the techniques of this disclosure is a method in a user equipment (UE) for activating reception of multicast and/or broadcast services (MBS), the method comprising: operating in an inactive state of a protocol for controlling radio resources; receiving, in the inactive state from a radio access network (RAN), a message including an MBS session identifier (ID); and initiating reception of MBS data corresponding to the MBS session ID in response to the message.

Another example embodiment of these techniques is a UE configured to implement the method above.

### BRIEF DESCRIPTION OF THE DRAWINGS

FIG. 1A is a block diagram of an example wireless communication system in which a RAN and/or a UE implement at least some of the techniques of this disclosure for managing transmission and reception of MBS;

FIG. 1B is a block diagram of an example base station including a central unit (CU) and a distributed unit (DU) that can operate in the system of FIG. 1A;

FIG. 2 is a block diagram of an example protocol stack according to which the UE of FIG. 1A communicates with base stations;

FIGS. 3A-3B are example message sequences in which a base station activates MBS transmission for an MBS session and one or more UEs operating an idle or inactive state activates MBS reception to receive the MBS session;

FIGS. 4A-4B are example message sequences in which a base station activates MBS transmission for an MBS session and one or more UEs operating an idle or inactive state activates MBS reception and transitions to a connected state to receive the MBS session;

FIGS. 5A-5C and FIGS. 6A-6C are flow diagrams of example methods for activating transmission of an MBS, which can be implemented by a base station; and

FIGS. 7, 8A-8B, 9-10, and 11A-11B are flow diagrams of example methods for receiving a MBS, which can be implemented by a UE.

### DETAILED DESCRIPTION OF THE DRAWINGS

Generally speaking, the techniques of this disclosure allow UEs to receive MBS information via radio resources allocated by a base station of a RAN. To this end, the base station can configure different radio resources in one or multiple overlapping cells to multicast or broadcast MBS data (and associated control information) and/or unicast non-MBS data (and associated control information) with one or multiple UEs on the downlink (DL). Note that “transmit” by a base station may interchangeably refer to “multicast”, “broadcast”, and/or “unicast.” The base station can also unicast MBS data (and associated control information) to a UE on a dedicated DRB for the UE. The one or more multiple UEs can transmit non-MBS data to the base station on the uplink (UL).

Accordingly, a base station of this disclosure can configure one or more radio bearers to transmit MBS information (i.e., MBS data packets and/or control information) to a UE. A radio bearer that carries MBS information to the UE can be a unicast DRB (i.e., a dedicated DRB for the UE) or a multicast DRB (i.e., a DRB that may be shared by multiple UEs, also referred to as an MBS radio bearer or MRB). For example, the base station can transmit unicast configuration parameters or multicast configuration parameters to the UE to configure the UE to receive MBS information via a unicast DRB or a multicast DRB, respectively. As used in this disclosure, the term DRB may refer to a unicast DRB or a multicast DRB, unless specifically noted otherwise.

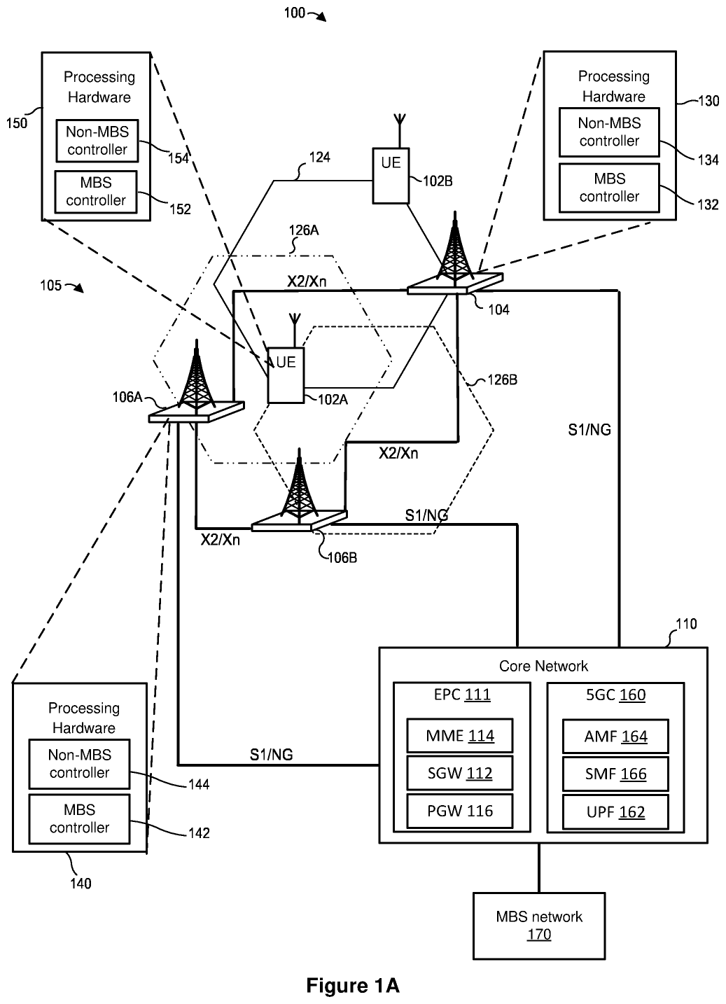

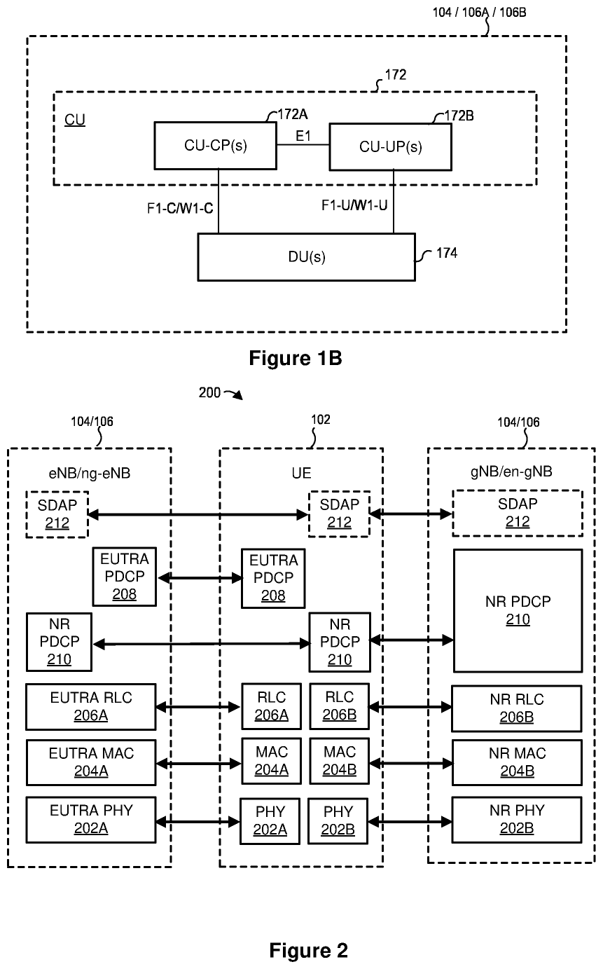

FIG. 1A depicts an example wireless communication system 100 that can implement MBS operation techniques of this disclosure. The wireless communication system 100 includes UE 102A and UE 102B, as well as base stations 104, 106A, 106B of a radio access network (RAN) (e.g., RAN 105) that are connected to a core network (CN) 110. To ease readability, UE 102 is used herein to represent the UE 102A, the UE 102B, or both the UE 102A and UE 102B, unless otherwise specified. The base stations 104, 106A, 106B can be any suitable type, or types, of base stations, such as an evolved node B (eNB), a next-generation eNB (ng-eNB), a 5G Node B (gNB) or a 6G base station, for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the UE 102 to operate in dual connectivity (DC) with the RAN 105. For example, the UE 102 can communicate in DC with the base station 104 (operating as a master node (MN)) and the base station 106A (operating as a secondary node (SN)) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

In non-MBS (i.e., unicast) operation, the UE 102 can use a radio bearer (e.g., a DRB or an SRB) that at different times terminates at an MN (e.g., the base station 104) or an SN (e.g., the base station 106). For example, after handover or SN change to the base station 106B, the UE 102 can use a radio bearer (e.g., a DRB or an SRB) that at different times terminates at the base station 106B. The UE 102 can apply one or more security keys when communicating on the radio bearer, in the uplink (UL) direction (i.e., from the UE 102 to a base station) and/or downlink (DL) direction (i.e., from a base station to the UE 102). In non-MBS operation, the UE 102 transmits data via the radio bearer on (i.e., within) an uplink BWP of a cell to the base station and/or receives data via the radio bearer on a DL BWP of the cell from the base station. The UL BWP can be an initial UL BWP or a dedicated UL BWP, and the DL BWP can be an initial DL BWP or a dedicated DL BWP. The UE 102 can receive paging, system information, public warning message(s), or a random access response on the DL BWP. In such non-MBS operation, the UE 102 can be in a connected state. Alternatively, the UE 102 can be in an idle or inactive state if the UE 102 supports small data transmission in the idle or inactive state.

In MBS operation, the UE 102 can use a radio bearer (e.g., a DRB or an MRB) that at different times terminates at an MN (e.g., the base station 104) or an SN (e.g., the base station 106A). For example, after handover or SN change to the base station 106B, the UE 102 can use a radio bearer (e.g., a DRB or an MRB) that at different times terminates at the base station 106B which can be an MN or SN. The base station can utilize the radio bearer to transmit application-level messages, such as security keys, to the UE 102. In some implementations, the base station (e.g., the MN or SN) can transmit MBS data over dedicated radio resources (i.e., the radio resources dedicated to the UE 102) to the UE 102 (e.g., via the DRB or MRB). In such implementations, the base station can apply one or more security keys to protect integrity of MBS data and/or encrypt MBS data and transmits the encrypted and/or integrity protected MBS data over the dedicated radio resources to the UE 102. Correspondingly, the UE 102 can apply the one or more security keys to decrypt MBS data and/or check integrity of the MBS data when receiving the MBS data on the radio bearer, in the downlink (from a base station to the UE 102) direction. In other implementations, the base station (e.g., the MN or SN) can transmit MBS data over common radio resources (i.e., the radio resources common to the UE 102 and other UE(s) such as common frequency resources (CFR)) or a DL BWP of a cell from the base station to the UE 102 (e.g., via the DRB or MRB). The DL BWP can be an initial DL BWP, a dedicated DL BWP, or an MBS DL BWP (i.e., a DL BWP specific for MBS or not for unicast). In such implementations, the base station can refrain from applying a security key to MBS data and transmit the MBS data on the radio bearer. Correspondingly, the UE 102 can omit applying a security key to MBS data received on the radio bearer. The UE 102 can apply an application-level security key, received from the CN 110 or an MBS server, to MBS data received on the radio bearer.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1A includes a base station MBS controller 132 that is configured to manage or control transmission of MBS information received from the CN 110 or an edge server. For example, the base station MBS controller 132 can be configured to support Radio Resource Control (RRC) configurations, procedures and messaging associated with MBS procedures, and/or to support the necessary operations (e.g., MBS activation notification), as discussed below. The processing hardware 130 can include a base station non-MBS controller 134 configured to manage or control one or more RRC configurations and/or RRC procedures when the base station 104 operates as an MN or SN during a non-MBS operation.

The base station 106A includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station MBS controller 142 that is configured to manage or control transmission of MBS information received from the CN 110 or an edge server. For example, the base station MBS controller 142 can be configured to support RRC configurations, procedures and messaging associated with MBS procedures, and/or to support the necessary operations (e.g., MBS activation notification), as discussed below. The processing hardware 140 can include a base station non-MBS controller 144 configured to manage or control one or more RRC configurations and/or RRC procedures when the base station 106A operates as an MN or SN during a non-MBS operation. While not shown in FIG. 1A, the base station 106B can include processing hardware similar to the processing hardware 130 of the base station 104 or the processing hardware 140 of the base station 106A.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE MBS controller 152 that is configured to manage or control reception of MBS information. For example, the UE MBS controller 152 can be configured to support RRC configurations, procedures and messaging associated with MBS procedures, and/or to support the necessary operations (e.g., MBS activation notification), as discussed below. The processing hardware 150 can include a UE non-MBS controller 154 configured to manage or control one or more RRC configurations and/or RRC procedures in accordance with any of the implementations discussed below, when the UE 102 communicates with an MN and/or an SN during a non-MBS operation.

The CN 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions. The UPF 162, AMF 164 and/or the SMF 166 can be configured to support MBS. For example, the SMF 166 can be configured to manage or control MBS transport, configure the UPF 162 and/or RAN 105 for MBS flows, and/or manage or configure MBS session(s) or PDU Session(s) for MBS for UE 102. The UPF 162 is configured to transfer MBS data packets to audio, video, Internet traffic, etc. to the RAN 105. The UPF 162 and/or SMF 166 can be configured for both unicast service and MBS, or for MBS only.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is an Sng-eNB, the UE 102 can be in NR-EUTRA DC (NE-DC) with the MgNB 104 and the Sng-eNB 106A.

With continued reference to FIG. 1A, the CN 110 communicatively connects the UE 102, to an MBS network 170, via the RAN 105. The MBS network 170 can provide to the UE 102 multicast and/or broadcast services (MBS) to UEs that can be useful in many content delivery applications, such as transparent IPv4/IPv6 multicast delivery, IPTV, software delivery over wireless, group communications, IoT applications, V2X applications, and emergency messages related to public safety. To this end, an entity (e.g., a server or a group of servers) operating in the MBS network 170 supports packet exchange with the UE. The packets can convey signaling (such as session initiation protocol (SIP) messages, IP messages, or other suitable messages) as well as data (“or media”) such as text messages, audio and/or video.

FIG. 1B depicts an example, distributed implementation of any one or more of the base stations 104, 106A, 106B. In this implementation, the base station 104, 106A, or 106B includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the non-MBS control information and MBS control information, and the CU-UP 172B can transmit the non-MBS data packets and MBS data packets, as described herein.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can be MBS packets or non-MBS packets. For example, the MBS packets include MBS data packets including application content for an MBS service (e.g., IPv4/IPv6 multicast delivery, IPTV, software delivery over wireless, group communications, IoT applications, V2X applications, and/or emergency messages related to public safety). In another example, the MBS packets include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2) or a DRB. The SN-terminated bearer can be an SRB or a DRB.

In some implementations, a base station (e.g., base station 104, 106A or 106B) broadcasts MBS data packets via one or more MBS radio bearers (MRB(s)), and in turn the UE 102 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102 uses PHY sublayer 202, MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204 and PHY sublayer 202, and correspondingly, the UE 102 uses PHY sublayer 202, MAC sublayer 204, RLC sublayer 206, PDCP sublayer 208, and the SDAP sublayer 212 to receive the MBS data packets.

To simplify the following description, the UE 102 represents the UE 102A and the UE 102B, unless explicitly described.

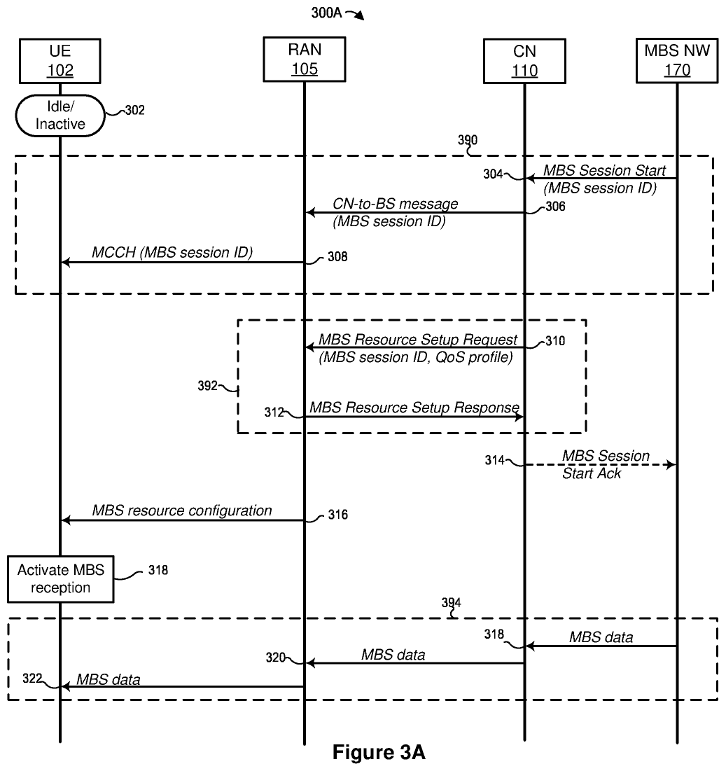

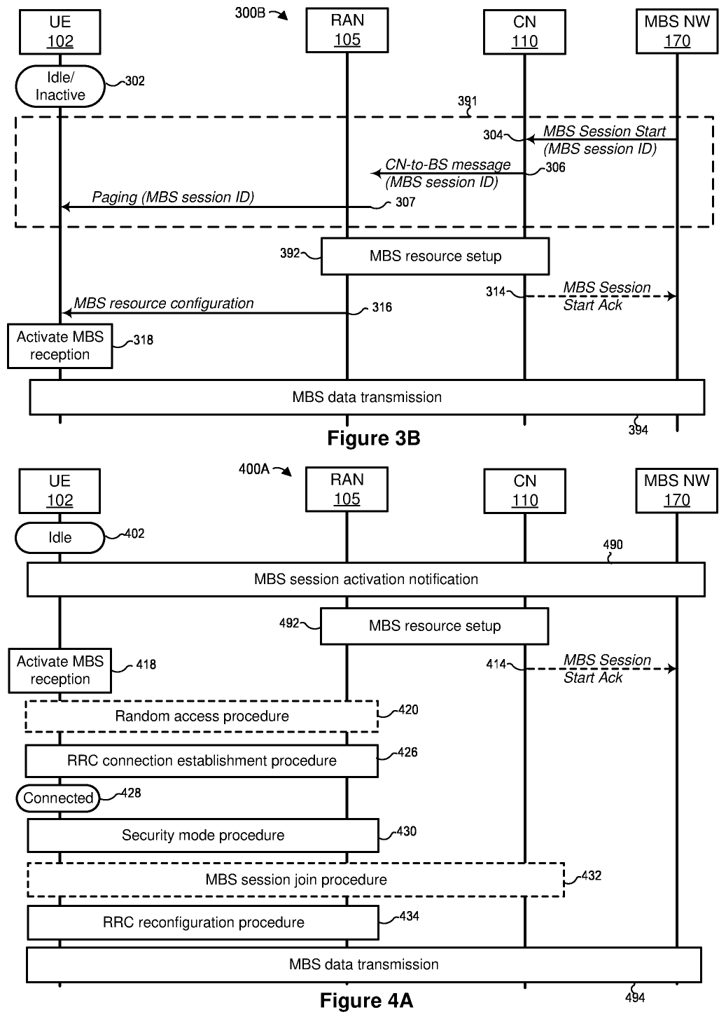

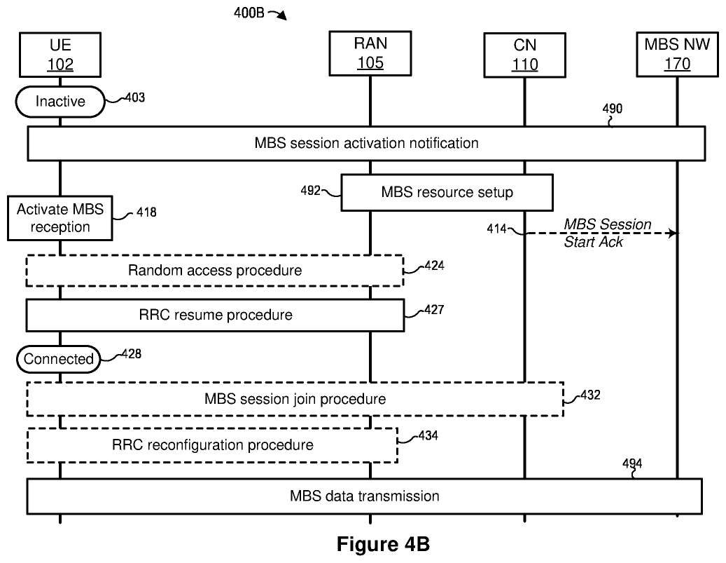

FIGS. 3A-4B are messaging diagrams of example scenarios in which one or more UEs, the RAN, the CN and the MBS network implement the techniques of this disclosure for managing MBS transmission and reception. Generally speaking, events in FIGS. 3A-4B that are similar are labeled with similar reference numbers, with differences discussed below where appropriate. With the exception of the differences shown in the figures and discussed below, any on the alternative implementations discussed with respect to a particular event (e.g., for messaging and processing) may apply to events labeled with similar reference numbers in other figures.

Now referring to a scenario 300A illustrated in FIG. 3A, UE 102 (e.g., the UE 102A and/or UE 102B) initially operates 302 in an idle state (e.g., RRC_IDLE state) or an inactive state (e.g., RRC_INACTIVE state) with RAN 105. In the following description, the RAN 105 can represent base station 104, base station 106, cell 124 of the base station 104 and/or cell 126 of the base station 106). For example, the UE 102 operating in the idle state or the inactive state camps on a cell 124 of base station 104 of the RAN 105. MBS network 170 sends 304 an MBS Session Start message (or called MBS Session Start Request message) to CN 110 (e.g., AMF 164) to requests activation of an MBS session. The MBS network 170 includes an MBS session ID to identifying the MBS session in the MBS Session Start message. In some implementations, the MBS session ID is allocated by the CN 110. In other implementations, the MBS session ID is allocated by the MBS network 170. In some implementations, the MBS session ID can be or include a Temporary Mobile Group Identity (TMGI). In other implementations, the MBS session ID can be associated with a TMGI.

In response to the MBS Session Start message, the CN 110 can notify UEs of activation of the MBS session. To notify UEs of the MBS session activation, the CN 110 generates a CN-to-BS message including the MBS session ID and sends 306 the CN-to-BS message to the RAN 105. In some implementations, the CN-to-BS message can be an existing or new next generation application protocol (NGAP) message defined in 3GPP specification 38.413. For example, the existing NGAP message can be a NGAP Paging message. In other implementations, the CN-to-BS message can be a 6G application protocol (6GAP) message.

Upon receiving 306 the CN-to-BS message, the RAN 105 extracts the MBS session ID from the CN-to-BS message and generates a message, including the MBS session ID, to be transmitted on a (first) multicast control channel (MCCH) (i.e., hereinafter referred to as MCCH message). Then the RAN 105 transmits (i.e., via broadcast) the MCCH message on a radio resource, e.g., on the cell 124. In some implementations, the RAN 105 can generate a DCI and a CRC of the DCI from the DCI to transmit the MCCH message. The RAN 105 scrambles the CRC with a particular radio network temporary identifier (RNTI). For example, the RNTI can be a MCCH-RNTI or an MBS-RNTI. The RAN 105 can broadcast system information (e.g., a system information block (SIB)), e.g., on the cell 124. The RAN 105 can include a downlink assignment in the DCI, which indicates the radio resource for a transmission of the MCCH message. The RAN 105 can transmit the DCI and the scrambled CRC on a PDCCH to the UE 102 and then transmit the MCCH message on the indicated radio resource. When the UE 102 receives the DCI and the scrambled CRC on the PDCCH, the UE 102 verifies the scrambled CRC with the RNTI. If the UE 102 verifies the scrambled CRC is valid, the UE 102 receives or attempts to receive 308 the MCCH message on the radio resource in accordance with the DCI. In other implementations, the RAN 105 does not transmit a DCI to allocate the radio resource for transmitting the MCCH message. Instead, the RAN 105 can broadcast system information (e.g., a SIB) including a configuration of the radio resource, e.g., on the cell 124.

Events 304, 306 and 308 collectively define an MBS session activation notification procedure 390.

After receiving 304 the MBS Session Start message, the CN 110 can send 312 to the RAN 105 an MBS Resource Setup Request message (e.g., MBS Session Resource Setup Request message) including the MBS session ID, to request the RAN 105 to assign resources on an air interface (e.g., Uu) and resources on a network interface (e.g., NG-U) between the RAN 105 and the CN 110 for an MBS session identified by the MBS session ID. In some implementations, the CN 110 can include in the MBS Resource Setup Request message a quality of service (QoS) profile to indicate QoS parameters associated to the MBS session. In some implementations, the CN 110 sends the MBS Resource Setup Request message in response to receiving the MBS Session Start message. In one implementation, the CN 110 sends the MBS Resource Setup Request message after transmitting 306 the CN-to-BS message. In another implementation, the CN 110 sends the MBS Resource Setup Request message before transmitting 306 the CN-to-BS message.

In response to the MBS Session Resource Setup message, the RAN 105 can assign radio resources for broadcasting data of MBS session and transmit 312 an MBS Resource Setup Response message (e.g., MBS Session Resource Setup Response message) to the CN 110. The radio resources include time resources (e.g., time slots or OFDM symbols), and/or frequency resources (e.g., resource blocks). The RAN 105 can broadcast 316 MBS resource configuration(s) to indicate or configure the radio resources, e.g., on the cell 124. The MBS resource configuration(s) can further configure modulation and coding scheme (MCS), repetitions and/or hybrid automatic repeat request (HARQ) transmission for broadcasting data of the MBS session. In some implementations, the RAN 105 can broadcast 316 system information including the MBS resource configuration(s) on a broadcast control channel (BCCH). In other implementations, the RAN 105 can broadcast 316 MBS resource configuration(s) on the first MCCH or a second MCCH. The CN 110 can send 314 an MBS Session Start Acknowledge message to the MBS network 170 in response to the MBS Session Start message. In some implementations, the CN 110 can send the MBS Session Start Acknowledge message after receiving the MBS Resource Setup Response message. In other implementations, the CN 110 can send the MBS Session Acknowledge message to the MBS network irrespective of receiving the MBS Resource Setup Response message.

Events 310 and 312 collectively define an MBS resource setup procedure 392.

After transmitting the MBS Session Start message or receiving the MBS Session Start Acknowledge message, the MBS network 170 can transmit 318 MBS data (e.g., one or more MBS data packets) of the MBS session to the CN 110, which in turn transmits 320 the MBS data to the RAN 105. The RAN 105 then broadcasts 322 the MBS data on the radio resources configured by the MBS resource configuration(s), e.g., on the cell 124.

After or in response to receiving 308 the MCCH message, the UE 102 in the idle state or the inactive state activates (e.g., initiates) 318 reception of the MBS session identified by the MBS session ID. The UE 102 receives 322 the MBS data in accordance with the MBS resource configuration(s). For example, the UE 102 receives 322 one or more DL transmissions including the MBS data on the radio resources configured by the MBS configuration(s) and decode the DL transmission(s) in accordance with the MCS to obtain the MBS data.

Events 318, 320 and 322 collectively define an MBS data transmission procedure 394.

Turning to FIG. 3B, a scenario 300B is similar to the scenario 300A, except that the RAN 105 transmits 307 a paging message including the MBS session ID instead of transmitting 308 the MCCH message, to notify the activation of the MBS session. The RAN 105 can transmit the paging message on a paging control channel (PCCH). In some implementations, the RAN 105 can generate a DCI and a CRC of the DCI from the DCI to transmit the paging message. The RAN 105 scrambles the CRC with a paging radio network temporary identifier (P-RNTI). The RAN 105 can include a downlink assignment in the DCI, which indicates a radio resource for a transmission of the paging message. The RAN 105 can transmit the DCI and the scrambled CRC on a PDCCH on the cell 124 to the UE 102 and the transmit the paging message on the indicated radio resource. When the UE 102 receives the DCI and the scrambled CRC on the PDCCH, the UE 102 verifies the scrambled CRC with the P-RNTI. If the UE 102 verifies the scrambled CRC is valid, the UE 102 receives or attempts to receive 307 the paging message on the radio resource in accordance with the DCI. After or in response to receiving 307 the paging message, the UE 102 in the idle state or the inactive state activates (e.g., initiates) 318 reception of the MBS session identified by the MBS session ID.

FIG. 4A and FIG. 4B are example message sequences similar to the message sequences of FIG. 3A and FIG. 3B, but where the UE 102 transitions to a connected state from the inactive state and the idle state, respectively.

Turning first to FIG. 4A, in a scenario 400A, the UE 102 initially operates 402 in the idle state. The UE 102 in the idle state receives an MBS activation notification message (i.e., the MCCH message or the paging message) in the MBS session activation notification procedure 490, similar to the MBS session activation notification procedure 390 or 391. In some implementations, the MBS session ID in FIG. 4A identifies a multicast session, and the MBS session ID in FIG. 3A and FIG. 3B identifies a broadcast session.

In response to the activation 418, the UE 102 performs 426 a RRC connection establishment procedure with the RAN 105. The UE 102 transitions 428 to a connected state (e.g., RRC_CONNECTED state) in response to the RRC connection establishment procedure. To perform 426 the RRC connection establishment procedure, the UE 102 can perform 424 a random access procedure with the RAN 105 to synchronize with the RAN 105 in uplink transmission, in cases where the UE 102 is not uplink synchronized with the RAN 105 (i.e., the UE 102 does not have a valid timing advance command or value with the RAN 105). The random access procedure can be a two-step or four-step random access procedure. To perform 426 the RRC connection establishment procedure, the UE 102 transmits a RRC request message (e.g., RRCSetupRequest message or RRCConnectionRequest message) to the RAN 105. In cases where the UE 102 performs 424 the two-step random access procedure, the UE 102 can transmit the RRC request message in a message A of the two-step random access procedure. In cases where the UE 102 performs 424 the four-step random access procedure, the UE 102 can transmit the RRC request message in a message 3 of the four-step random access procedure. In cases where the UE 102 is uplink synchronized with the RAN 105 and has a configured grant configuration for the idle state, the UE 102 can skip or omit the random access procedure. In such cases, the UE 102 can transmit the RRC Request message using a configured grant configured by the configured grant configuration. In response to the RRC request message, the RAN 105 can transmit a RRC response message (e.g., RRCSetup message or RRCConnectionSetup message) to the UE 102. In response, the UE 102 transitions 428 to the connected state and transmits a RRC complete message (e.g., RRCSetupComplete message or RRCConnectionSetupComplete message) to the RAN 105. In some implementations, the UE 102 configures a first SRB (e.g., SRB1) to communicate RRC messages with the RAN 105 in response to the RRC response message. In such implementations, the UE 102 transmits the RRC complete message via the first SRB to the RAN 105. In some implementations, the UE 102 can send a Service Request message to the CN 110 via the RAN 105 after transitioning 428 to the connected state. In one implementation, the UE 102 can include the Service Request message in the RRC complete message. The RAN 105 retrieves the Service Request message from the RRC complete message sends a first BS-to-CN message (e.g., Initial UE Message message) including the Service Request message to the CN 110.

After performing 426 the RRC connection establishment procedure with the UE 102 or transitioning 428 to the connected state, the RAN 105 can perform 430 a security activation procedure (e.g., RRC security mode procedure) with the UE 102 to activate security (e.g., integrity protection/integrity check and/or encryption/decryption) on communication with the UE 102. In details, the RAN 105 can send a security activation command message (e.g., SecurityModeCommand message) to the UE 102, e.g., via the SRB, to perform 430 the security activation procedure. In response, the UE 102 activate security (e.g., integrity protection and/or encryption) on communication with the RAN 105 and transmits a security activation complete message (e.g., SecurityModeComplete) to the RAN 105, e.g., via the SRB. After activating the security, the RAN 105 can perform a RRC reconfiguration (not shown in FIG. 4A) with the UE 102 to configure a second SRB (e.g., SRB2) and/or a DRB to exchange RRC messages and/or NAS message with the UE 102.

After transitioning 428 to the connected state or performing 430 the security activation procedure, the UE 102 can perform 432 an MBS session join procedure (or called an MBS session activation procedure or MBS session establishment procedure) with the CN 110 via the RAN 105 to indicate that the UE 102 requests to join the MBS session. In some implementations, the UE 102 may (determine to) do so if the UE 102 does not have an MBS context for receiving the MBS session. In cases where the UE 102 has an MBS context for receiving the MBS session before receiving the message including the MBS session ID in the MBS session activation notification procedure 490, the UE 102 can skip, omit or refrain from performing the MBS session join procedure. To perform 432 the MBS session join procedure, the UE 102 can send an MBS session join request message (or called MBS session activation request message or MBS session establishment request message) to the CN 110 via the RAN 105. In response, the CN 110 can send an MBS session join accept message (or called MBS session activation accept message or MBS session establishment accept message) to the UE 102 via the RAN 105. In some implementations, the UE 102 can perform the MBS session join procedure after activating 430 the security. Thus, the MBS session join procedure is protected by the security. Upon receiving the MBS session join request message from the UE 102, the RAN 105 can send a second BS-to-CN message (e.g., Uplink NAS Transport message) including the MBS session join request message to the CN 110. In other implementations, the UE 102 can perform the MBS session join procedure after transitioning 428 to the connected state and before activating the security. In one implementation, the UE 102 can include the MBS session join request message in the RRC complete message. The RAN 105 retrieves the MBS session join request from the RRC complete message and sends the first BS-to-CN message including the MBS session join request message to the CN 110. In this implementation, the UE 102 may determine not to send the Service Request message.

Alternatively, the UE 102 can perform the MBS session join procedure with the MBS network 170 via the CN 110 and the RAN 105, instead of the CN 110. In such case, the CN 110 sends the MBS session join request message to the MBS network 170 and receives the MBS session join accept message from the MBS network 170, respectively.

In some implementations, the MBS context includes the MBS session ID. In further implementations, the MBS context can include a QoS profile of the MBS session, an IP address for the MBS session, and/or one or more MRB configurations configuring one or more MRBs.

In some implementations, the CN 110 can initiate the MBS resource setup procedure 492 in response to or after receiving the first BS-to-CN message or the second BS-to-CN message. In response to or after receiving the MBS Resource Setup Request message, the RAN 105 can perform 434 a RRC reconfiguration procedure with the UE 102 to configure radio resources for the UE 102 to receive 494 MBS data of the MBS session. To perform 434 the RRC reconfiguration procedure, the RAN 105 sends a RRC reconfiguration message to the UE 102. The RAN 105 can include, in the RRC reconfiguration message, configuration parameters for the UE 102 to receive 494 MBS data of the MBS session. In some implementations, the RAN 105 can set configuration parameters in accordance with the QoS profile. The UE 102 receives the MBS data in the MBS data transmission procedure 494 in accordance with the configuration parameters. In some implementations, the configuration parameters may include physical layer configuration parameter(s), MAC configuration parameter(s), RLC configuration parameter(s), PDCP configuration parameter(s), SDAP configuration parameter(s) and/or MRB configuration parameter(s). The MRB configuration parameter(s) can configure one or more MRBs associated to the MBS session.

In response to the RRC reconfiguration message, the UE 102 can send a RRC reconfiguration complete message to the RAN 105. After or in response to receiving the MBS Resource Setup Request message, the RAN 105 can send the MBS Resource Setup Response message to the CN 110. In some implementations, the RAN 105 can send the MBS Resource Setup Response message to the CN 110 before or after receiving the RRC reconfiguration complete message. In other implementations, the CN 110 may perform 492 the MBS resource setup procedure with the RAN 105 before receiving the first BS-to-CN message or the second BS-to-CN message. In yet other implementations, the CN 110 may perform 492 the MBS resource setup procedure with the RAN 105 irrespective of receiving the first BS-to-CN message or performing the MBS session join procedure.

After receiving 414 the MBS Session Start Acknowledge message, the MBS network 170 can perform 494 an MBS data transmission procedure to send MBS data to the UE 102. When the RAN 105 receive MBS data from the CN 110 during the MBS data transmission procedure, the RAN 105 can transmit the MBS data to the UE 102 via multicast. After performing the RRC reconfiguration procedure, the UE 102 uses the configuration parameters to receive 322 the MBS data from the RAN 105. In some implementations, the RAN 105 can transmit the MBS data to the UE 102 via the one or more MRBs and the UE 102 can receive the MBS data via the one or more MRBs.

Turning to FIG. 4B, a scenario 400B is similar to the scenario 400A, except that the UE 102 initially operates 403 in an inactive state (e.g., RRC_INACTIVE), and in response to receiving the MBS activation notification message, the UE 102 performs an RRC resume procedure rather than the RRC connection establishment procedure. In some scenarios and implementations, the UE 102 was in a connected state with the RAN 105, before the UE 102 operates 403 in the inactive state. The UE 102 in the connected state communicates data with the RAN 105, e.g., via one or more radio bearers (RBs). In some implementations, the UE 102 in the connected state communicates the control-plane (CP) data via one or more signaling RBs (SRBs). In some implementations, the UE 102 in the connected state communicates the user-plane (UP) data via one or more data RBs (DRBs). After a certain period of data inactivity for the UE 102, the RAN 105 can determine that neither the RAN 105 nor the UE 102 has transmitted any data in the downlink direction or the uplink direction, respectively, during the certain period. In response to the determination, the RAN 105 can transmit a RRC release message (e.g., RRCRelease message or RRCConnectionRelease message) to the UE 102 and instruct the UE 102 to transition to the inactive state. The UE 102 transitions to the inactive state upon receiving the RRC release message. The RAN 105 can assign an I-RNTI or a resume ID to the UE 102 and include the assigned value in the RRC release message. In some embodiments, after the UE 102 transitions to the inactive state, the UE 102 may perform one or more RAN notification area (RNA) updates with the RAN 105 without state transitions.

In response to the activation 418, the UE 102 can perform 427 an RRC resume procedure with the RAN 105. The UE 102 transitions 428 to a connected state (e.g., RRC_CONNECTED state) in response to the RRC resume procedure. To perform 427 the RRC resume procedure, the UE 102 can perform 424 a random access procedure with the RAN 105 to synchronize with the RAN 105 in uplink transmission, in cases where the UE 102 is not uplink synchronized with the RAN 105 (i.e., the UE 102 does not have a valid timing advance command or value with the RAN 105). The random access procedure can be a two-step or four-step random access procedure. To perform 427 the RRC resume procedure, the UE 102 transmits a RRC request message (e.g., RRCResumeRequest message or RRCConnectionResumeRequest message) to the RAN 105. In cases where the UE 102 performs 424 the two-step random access procedure, the UE 102 can transmit the RRC request message in a message A of the two-step random access procedure. In cases where the UE 102 performs 424 the four-step random access procedure, the UE 102 can transmit the RRC request message in a message 3 of the four-step random access procedure. In cases where the UE 102 is uplink synchronized with the RAN 105 and has a configured grant configuration for the idle state, the UE 102 can skip or omit the random access procedure. In such cases, the UE 102 can transmit the RRC request message using a configured grant configured by the configured grant configuration. In response to the RRC request message, the RAN 105 can transmit a RRC response message (e.g., RRCResume message or RRCConnectionResume message) to the UE 102. In response, the UE 102 transitions 418 to the connected state and transmits a RRC complete message (e.g., RRCResumeComplete message or RRCConnectionResumeComplete message) to the RAN 105. In some implementations, the UE 102 operating 403 in the inactive state suspends a first SRB (e.g., SRB1), a second SRB and/or one or more DRBs. In such implementations, the UE 102 resumes the first SRB to receive the RRC response message in response to or after transmitting the RRC request message and transmits the RRC complete message via the first SRB to the RAN 105. The UE 102 can resume the second SRB in response to the RRC response message. In some implementations, the UE 102 resumes the one or more DRBs in response to the RRC response message, in cases where the RAN 105 does not indicate release of the one or more DRBs. In some implementations, the UE 102 may not send a Service Request message to the CN 110 via the RAN 105 after transitioning 428 to the connected state, unlike FIG. 4A.

In some implementations, the UE 102 operating 403 in the inactive state has an MBS context for the MBS session as described for FIG. 4A. The UE 102 in the inactive state suspends one or more MRBs in the MBS context. In such implementations, the UE 102 resumes one or more MRBs in response to the RRC response message, in cases where the RAN 105 does not indicate release of the one or more MRBs in the RRC response message.

In some implementations, the UE 102 in the MBS data transmission procedure 494 can receive MBS data of the MBS session (i.e., a first MBS session) via (one, some or all of) the one or more MRBs that the UE 102 resumed in response to the RRC resume procedure. In such implementations, the UE 102 refrains from performing an MBS session join procedure to active reception of the MBS session. In other implementations, the UE 102 performs 432 the MBS session join procedure, in cases where the UE 102 does not have an MBS context for the MBS session. In some scenarios and implementations, the UE 102 may have an MBS context for a second MBS session and resumes one or more MRBs for the second MBS session in response to the RRC resume procedure or the RRC response message. In such cases, the UE 102 cannot receive MBS data of the first MBS session via the one or more MRBs of the MBS context for the second MBS session. Thus, the UE 102 performs the MBS session join procedure to cause the RAN 105 to perform 434 the RRC reconfiguration procedure to configure radio resources for the UE 102 to receive MBS data of the first MBS session. The UE 102 receives the MBS data in the MBS data transmission procedure 494 in accordance with the configuration parameters. In some implementations, the configuration parameters may include physical layer configuration parameters, MAC configuration parameters, RLC configuration parameters, PDCP configuration parameters, SDAP configuration parameters and/or MRB configuration parameters.

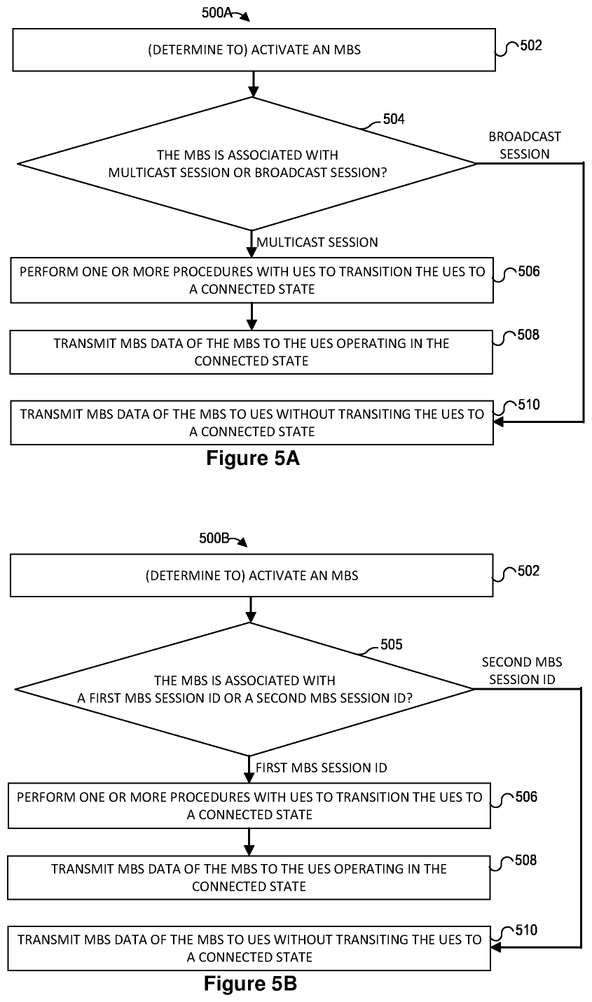

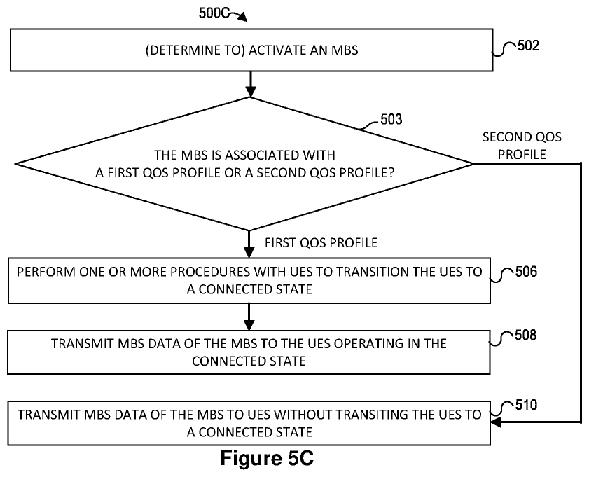

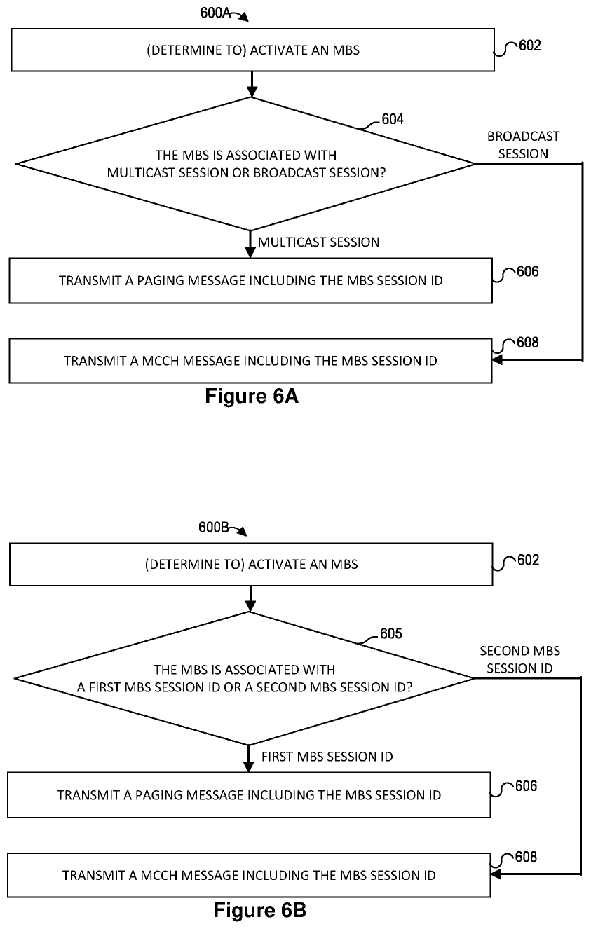

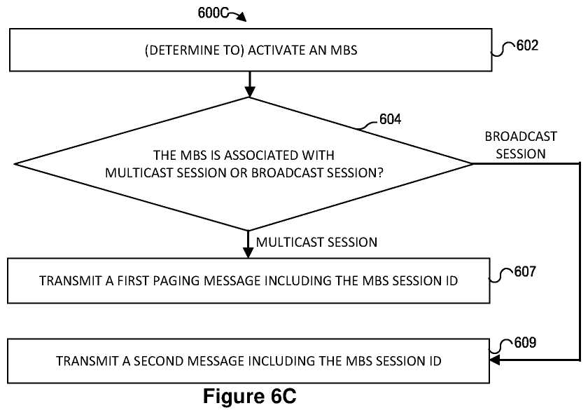

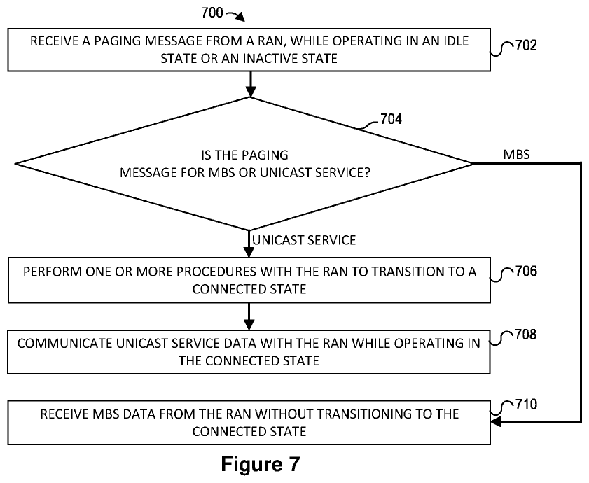

FIG. 5A-6C are flow diagrams depicting example methods that a base station (e.g., the base station 104, 106A or 106B) can implement to activate transmission of an MBS. FIGS. 7-11B are flow diagrams depicting example methods that a UE (e.g., the UE 102A or the UE 102B) can implement to activate reception of an MBS. FIG. 12A-13B are flow diagrams depicting example methods that a core network (e.g., the CN 110, the AMF 164) can implement to activate transmission of an MBS.

Blocks in FIGS. 5A-5C that are the same are labeled with the same reference numbers.

FIG. 5A is a flow diagram of an example method 500A for activating transmission of an MBS. At block 502, the RAN node (e.g., base station 104 or CU 172) determines to activate or activates an MBS. At block 504, the RAN node determines whether the MBS is associated with a multicast session or a broadcast session. If the MBS is associated with a multicast session, the flow proceeds to blocks 506 and 508. At block 506, the RAN node performs one or more procedures with plural UEs to transition the plural UEs to a connected state (e.g., events 424, 426, 427, 428). At block 508, the RAN node transmits MBS data of the MBS to the plural UEs operating in the connected state (e.g., event 494). If the MBS is associated with a broadcast session, the flow proceeds to block 510. At block 510, the RAN node transmits MBS data of the MBS to the plural UEs, without transitioning the plural UEs to the connected state (e.g., event 322).

FIG. 5B is a flow diagram of an example method 500B for activating transmission of an MBS. At block 502, the RAN node determines to activate or activates an MBS. At block 504, the base station determines whether the MBS is associated with a first MBS session ID or a second MBS session ID. If the MBS is associated with the first MBS session ID, the flow proceeds to blocks 506 and 508. At block 506, the RAN node performs one or more procedures with plural UEs to transition the plural UEs to a connected state (e.g., events 424, 426, 427, 428). At block 508, the RAN node transmits MBS data of the MBS to the plural UEs operating in the connected state (e.g., event 494). If the MBS is associated with the second MBS session ID, the flow proceeds to block 510. At block 510, the RAN node transmits MBS data of the MBS to the plural UEs, without transitioning the plural UEs to the connected state (e.g., event 322).

In some implementations, the first and second MBS session IDs may be associated with a multicast session and a broadcast session, respectively. In other implementations, the first and second MBS session IDs may be associated with a first MBS session and a second MBS session with different QoS requirements, respectively. For example, the first MBS session requires a QoS requirement (e.g., more reliable transmission, less block error rate, less latency and/or higher date rate) higher than the second MBS session. Thus, the RAN node transitions the plural UEs to transition to the connected state to provide the plural UEs configuration parameters to enforce the QoS requirement for the first MBS session.

FIG. 5C is a flow diagram of an example method 500C for activating transmission of an MBS. At block 502, the RAN node determines to activate or activates an MBS. At block 504, the RAN node determines whether the MBS is associated with a first QoS profile or a second QoS profile. If the MBS is associated with the first QoS profile, the flow proceeds to blocks 506 and 508. At block 506, the RAN node performs one or more procedures with plural UEs to transition the plural UEs to a connected state (e.g., events 424, 426, 427, 428). At block 508, the RAN node transmits MBS data of the MBS to the plural UEs operating in the connected state (e.g., event 494). If the MBS is associated with the second QoS profile, the flow proceeds to block 510. At block 510, the RAN node transmits MBS data of the MBS to the plural UEs, without transitioning the plural UEs to the connected state (e.g., event 322).

For example, the first QoS profile has different QOS requirements (e.g., more reliable transmission, less block error rate, less latency and/or higher date rate) from the second QoS profile. Thus, the RAN node transitions the plural UEs to transition to the connected state to provide the plural UEs configuration parameters to enforce the QoS requirements of the first QoS profile.

Blocks in FIGS. 6A-6C that are the same are labeled with the same reference numbers.

FIG. 6A is a flow diagram of an example method 600A for activating transmission of an MBS. At block 602, the RAN node determines to activate or activates an MBS. At block 604, the RAN node determines whether the MBS is associated with a multicast session or a broadcast session. If the MBS is associated with a multicast session, the flow proceeds to block 606. At block 606, the RAN node transmits a paging message including the MBS session ID (e.g., via broadcast and/or on a PCCH) (e.g., events 307). If the MBS is associated with a broadcast session, the flow proceeds to block 608. At block 608, the RAN node transmits a MCCH message including the MBS session ID (e.g., via broadcast) (e.g., events 308).

FIG. 6B is a flow diagram of an example method 600B for activating transmission of an MBS. At block 602, the RAN node determines to activate or activates an MBS. At block 604, the RAN node determines whether the MBS is associated with a first MBS session ID or a second MBS session ID. If the MBS is associated with the first MBS session ID, the flow proceeds to block 606. At block 606, the base station transmits a paging message including the MBS session ID (e.g., via broadcast and/or on a PCCH) (e.g., events 307). If the MBS is associated with the second MBS session ID, the flow proceeds to block 608. At block 608, the base station transmits a MCCH message including the MBS session ID (e.g., via broadcast) (e.g., events 308).

In some implementations, the first and second MBS session IDs may be associated with a multicast session and a broadcast session, respectively. In other implementations, the first and second MBS session IDs may be associated with a first MBS session and a second MBS session with different QoS requirements, respectively. For example, the first MBS session requires a QoS requirement (e.g., more reliable transmission, less block error rate, less latency and/or higher date rate) higher than the second MBS session. Thus, the RAN node transitions the plural UEs to transition to the connected state to provide the plural UEs configuration parameters to enforce the QoS requirement for the first MBS session.

FIG. 6C is a flow diagram of an example method 600C for activating transmission of an MBS. At block 602, the RAN node determines to activate or activates an MBS. At block 604, the RAN node determines whether the MBS is associated with a multicast session or a broadcast session. If the MBS is associated with a multicast session, the flow proceeds to block 607. At block 606, the RAN node transmits a first paging message including the MBS session ID and indicating a multicast session for the MBS session ID (e.g., via broadcast and/or on a PCCH) (e.g., events 307). In some implementations, the RAN node can include a multicast indication in the first paging message to indicate a multicast session for the MBS session ID. In other implementations, the RAN node can exclude a broadcast indication in the first paging message to indicate a multicast session for the MBS session ID. Thus, in accordance with the indication in the first paging message, the UE can determine to transition to the connected state to receive MBS data of the MBS.

If the MBS is associated with a broadcast session, the flow proceeds to block 609. At block 609, the RAN node transmits a second paging message including the MBS session ID and indicating a broadcast session for the MBS session ID (e.g., via broadcast and/or on a PCCH) (e.g., events 307). In some implementations, the RAN node can include a broadcast indication in the second paging message to indicate a broadcast session for the MBS session ID. In other implementations, the RAN node can exclude a multicast indication in the second paging message to indicate a broadcast session for the MBS session ID. Thus, in accordance with the indication in the second paging message, the UE can determine to remain in the idle or inactive state to receive MBS data of the MBS.

FIG. 7 is a flow diagram of an example method 700 for activating reception of an MBS. At block 702, the UE receives a paging message from a RAN, while operating in an idle state or an inactive state (e.g., events 302, 307, 402, 403, 490). At block 704, the UE determines whether the paging message for an MBS or a unicast service. If the paging message pages for a unicast service, the flow proceeds to blocks 706 and 708. If the paging message pages for an MBS, the flow proceeds to block 710. At block 706, the UE performs one or more procedures with the RAN to transition to a connected state in response to receiving the paging message. At block 708, the UE communicates unicast service data with the RAN while operating in the connected state. At block 710, the UE receives MBS data from the RAN without transitioning to the connected state, in response to the paging message for an MBS (e.g., event 322). In other words, the UE at block 710 refrains from transitioning to the connected state in response to the paging message for an MBS.

In some implementations, the UE can activate or initiate reception of an MBS in response to receiving the paging message (e.g., events 318, 418). In some implementations, the one or more procedures include a random access procedure and/or a RRC connection establishment procedure, similar to events 424, 426, 427. In some implementations, the UE in the connected state can perform a security mode procedure and/or a RRC reconfiguration procedure with the RAN to activate security (e.g., encryption and/or integrity protection) and/or configure a DRB, respectively, similar to events 430, 434. The UE communicates the unicast data with the RAN over the DRB with the security.

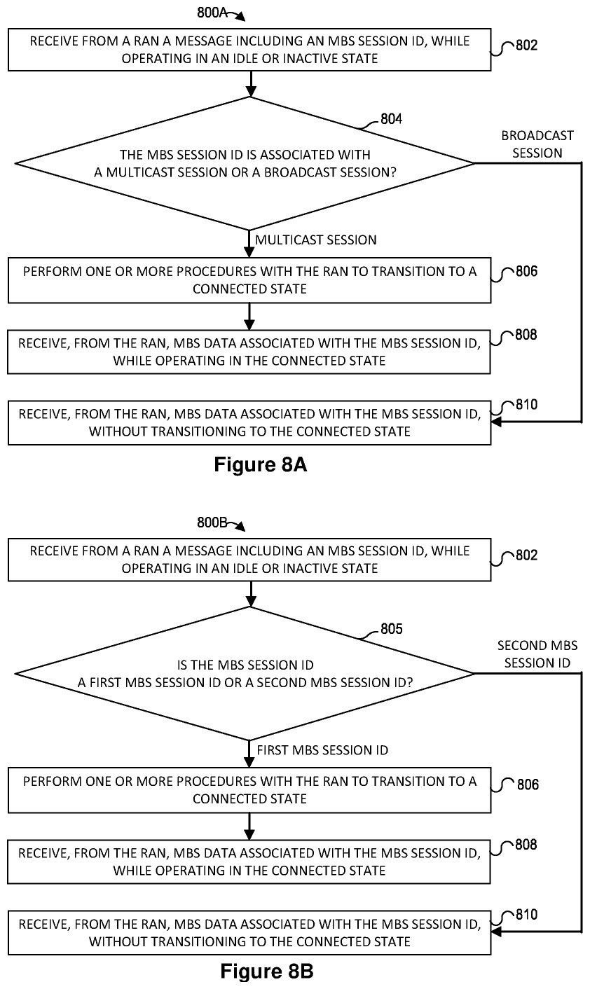

Blocks in FIGS. 8A-8B that are the same are labeled with the same reference numbers.

FIG. 8A is a flow diagram of an example method 800A for activating reception of an MBS. At block 802, the UE receives from a RAN a message including an MBS session ID, while operating in an idle or inactive state (e.g., events 302, 307, 308, 402, 403, 490). At block 804, the UE determines whether the MBS session ID is associated with a multicast session or a broadcast session. If the MBS session ID is associated with a multicast session, the flow proceeds to blocks 806 and 808. At block 806, the UE performs one or more procedures with the RAN to transition to a connected state (e.g., events 424, 426, 427, 428). At block 808, the UE receives, from the RAN, MBS data associated with the MBS session ID, while operating in the connected state (e.g., event 494).

If the MBS session ID is associated with a broadcast session, the flow proceeds to block 810. At block 810, the UE receives, from the RAN, MBS data associated with the MBS session ID, without transitioning to the connected state (e.g., event 322).

In some implementations, the UE can activate or initiate reception of an MBS in response to receiving the message or the MBS session ID (e.g., events 318, 418). In some implementations, the UE in the connected state can perform a security mode procedure and/or a RRC reconfiguration procedure with the RAN to activate security (e.g., encryption and/or integrity protection) and/or configure an MRB, respectively (e.g., events 430, 434). The UE in the connected state receives the MBS data from the RAN via the MRB.

In some implementations, the UE can determine the MBS session ID is associated with a multicast session if the message at block 802 indicates the MBS session ID is associated with a multicast session as described for FIG. 6C. In other implementations, the UE can determine the MBS session ID is associated with a multicast session if the UE performs a multicast session procedure for the MBS session ID with the CN 110 or the MBS network 170 via the RAN.

In some implementations, the UE can determine the MBS session ID is associated with a broadcast session if the message at block 802 indicates the MBS session ID is associated with a broadcast session as described for FIG. 6C. In other implementations, the UE can determine the MBS session ID is associated with a broadcast session if the UE does not perform a multicast session procedure for the MBS session ID with the CN 110 or the MBS network 170 via the RAN. In yet other implementations, the UE can determine the MBS session ID is associated with a broadcast session if the UE performs a broadcast session procedure for the MBS session ID with the CN 110 or the MBS network 170 via the RAN.

FIG. 8B is a flow diagram of an example method 800B for activating reception of an MBS. At block 802, the UE receives from a RAN a message including an MBS session ID, while operating in an idle or inactive state (e.g., events 302, 307, 308, 402, 403, 490). At block 805, the UE determines whether the MBS session ID a first MBS session ID or a second MBS session ID. If the MBS session ID is the first MBS session ID the flow proceeds to blocks 806 and 808. At block 806, the UE performs one or more procedures with the RAN to transition to a connected state (e.g., events 424, 426, 427, 428). At block 808, the UE receives, from the RAN, MBS data associated with the MBS session ID (i.e., the first MBS session ID), while operating in the connected state (e.g., event 494). If the MBS session ID is the second MBS session ID, the flow proceeds to block 810. At block 810, the UE receives, from the RAN, MBS data associated with the MBS session ID (i.e., the second MBS session ID), without transitioning to the connected state (e.g., event 322). In other words, the UE at block 810 refrains from transitioning to the connected state in response to receiving the message including the second MBS session ID.

In some implementations, the first and second MBS session IDs may be associated with a multicast session and a broadcast session, respectively. In other implementations, the first and second MBS session IDs may be associated with a first MBS (session) and a second MBS (session) with different QoS requirements, respectively. For example, the first MBS (session) requires a QoS requirement (e.g., more reliable transmission, less block error rate, less latency and/or higher date rate) higher than the second MBS (session). Thus, the UE transitions to the connected state to obtain configuration parameters meeting the QoS requirement for the first MBS.

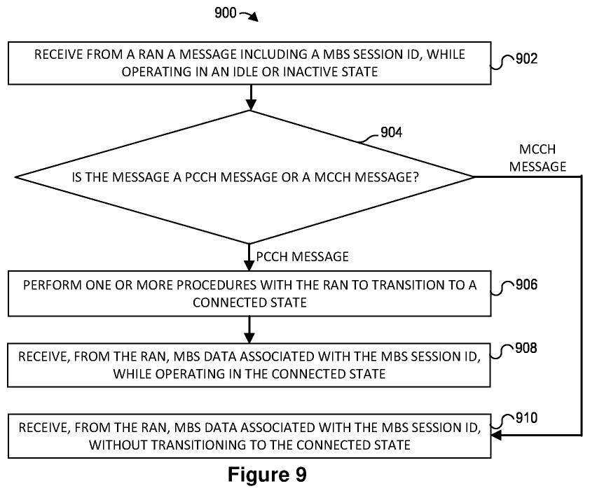

FIG. 9 is a flow diagram of an example method 900 for activating reception of an MBS, similar to the method 800. Example implementations of FIG. 8 can apply to FIG. 8.

At block 902, the UE receives from a RAN a message including an MBS session ID, while operating in an idle or inactive state (e.g., events 302, 307, 308, 402, 403, 490). At block 704, the UE determines whether the message a PCCH message or a MCCH message (e.g., events 307, 308, 490). If the message is a PCCH message, the flow proceeds to blocks 906 and 908. At block 906, the UE performs one procedure with the RAN to transition to a connected state (e.g., events 424, 426, 427, 428). At block 908, the UE receives, from the RAN, MBS data associated with the MBS session ID, while operating in the connected state (e.g., event 494). If the message is a MCCH message, the flow proceeds to block 910. At block 910, the UE receives, from the RAN, MBS data associated with the MBS session ID, without transitioning to the connected state (e.g., event 322).

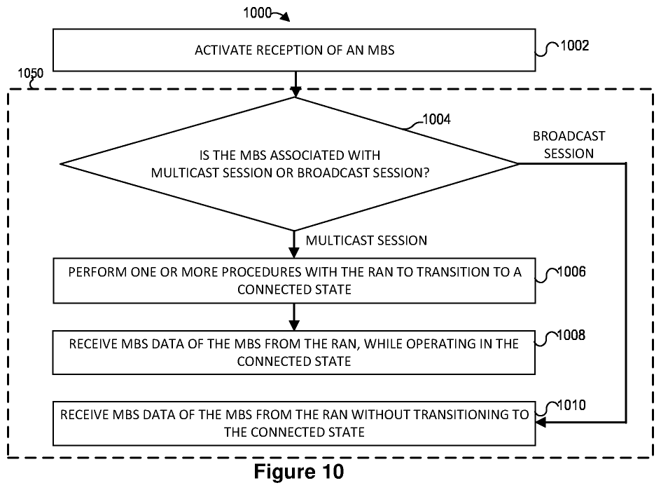

FIG. 10 is a flow diagram of an example method 1000 for activating reception of an MBS. At block 1002, the UE activates reception of an MBS (e.g., event 318, 418). In some implementations, the UE can activate reception of the MBS in response to receiving an MBS activation notification message notifying the UE of the MBS to be transmitted. In other implementations, the UE can activate reception of the MBS without receiving the MBS activation notification message.

At block 1004, the UE determines whether the MBS is associated with a multicast session or a broadcast session. If the MBS is associated with a multicast session, the flow proceeds to blocks 1006 and 1008, similar to blocks 806 and 808 respectively. At block 1006, the UE performs one or more procedures with the RAN to transition to a connected state (e.g., events 424, 426, 427, 428). At block 1008, the UE receives MBS data of the MBS from the RAN, while operating in the connected state (e.g., event 494). If the MBS is associated with a broadcast session, the flow proceeds to block 1010. At block 1010, the UE receives MBS data of the MBS from the RAN without transitioning to the connected state (e.g., event 322).

Blocks 1004, 1006, 1008 and 1010 collectively define an MBS reception procedure 1050.

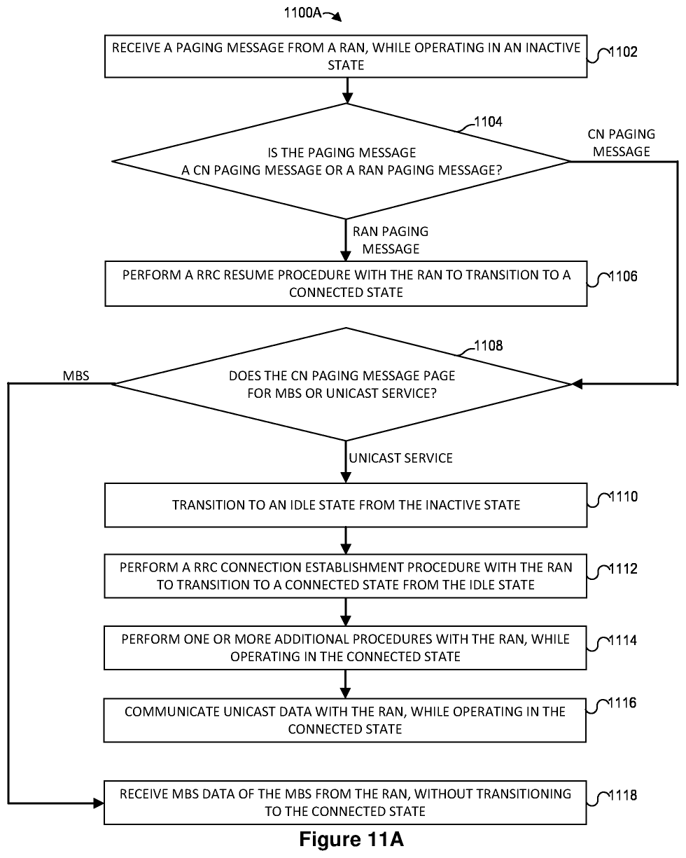

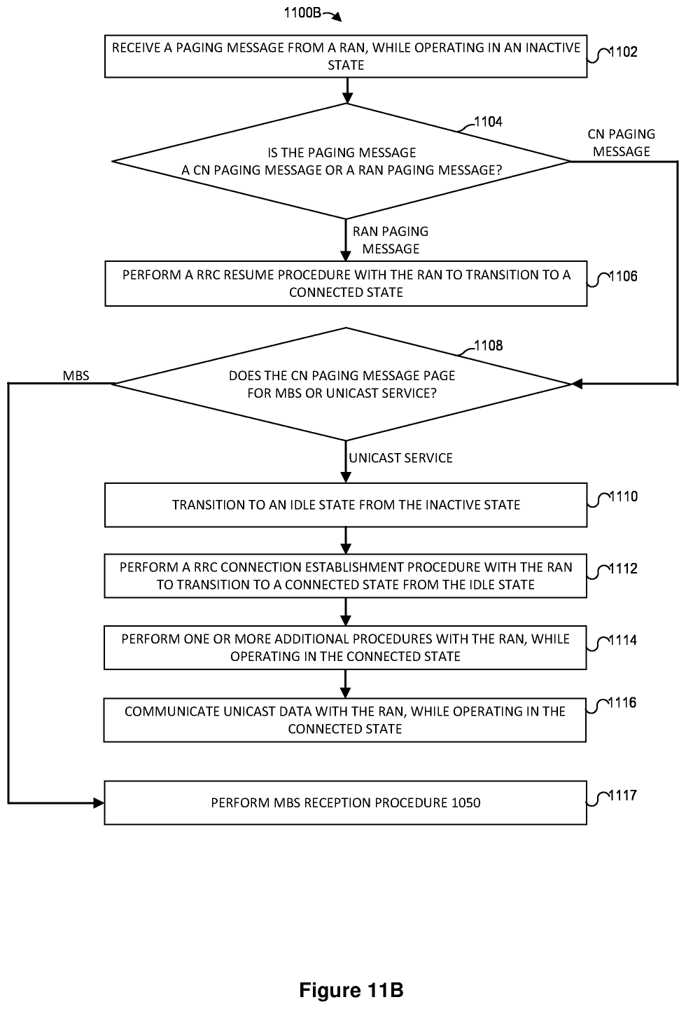

Blocks in FIGS. 11A-11B that are the same are labeled with the same reference numbers.

FIG. 11A is a flow diagram of an example method 1100A for activating reception of an MBS. At block 1102, the UE receives a paging message from a RAN, while operating in an inactive state (e.g., event 302, 307, 403, 490). At block 1104, the UE determines whether the paging message is a CN paging message (i.e., the CN triggers transmission of the paging message) or a RAN paging message (i.e., the RAN triggers transmission of the paging message). In some implementations, the RAN paging message includes a RAN ID. For example, the RAN ID can be an inactive radio network temporary identifier (I-RNTI) or a resume ID. In some implementations, the CN paging message can include a CN ID. For example, the CN ID can be an MBS session ID or a NAS ID of the UE. The NAS ID can be a 5G-S-TMSI.

If the paging message is a RAN paging message, the flow proceeds to block 1106. At block 1106, the UE performs a RRC resume procedure with the RAN to transition to a connected state, in response to the paging message (e.g., event 427). If the paging message is CN paging message, the flow proceeds to block 1108. At block 1108, the UE determines whether the CN paging message pages for an MBS or a unicast service. If the CN paging message pages for a unicast service, the flow proceeds to blocks 1110, 1112, 1114 and 1116. At block 1110, the UE transitions to an idle state from the inactive state in response to the paging message. At block 1112, the UE performs a RRC connection establishment procedure with the RAN in response to receiving the paging message (e.g., event 426). At block 1114, the UE performs one or more additional procedures with the RAN, while operating in the connected state (e.g., events 430, 434). After performing the one or more additional procedures with the RAN, the UE communicates unicast data with the RAN while operating in the connected state.

If the CN paging message pages for an MBS, the flow proceeds to block 1118. At block 1118, the UE receives MBS data of the MBS from the RAN, without transitioning to the connected state (e.g., event 322).

FIG. 11B is a flow diagram of an example method 1100B for activating reception of an MBS. If the CN paging message pages for an MBS, the flow proceeds to block 1117. At block 1117, the UE performs the MBS reception procedure 1050.

The following additional considerations apply to the foregoing discussion.

In some implementations, the UE can receive data of an MBS in a broadcast session without performing a session join procedure for receiving the MBS. That is, the UE does not need to perform a session join procedure for a broadcast session. In other implementations, the UE can receive data of an MBS in a broadcast session in accordance with configuration parameters broadcast by the RAN, i.e., without performing a RRC reconfiguration procedure to receive configuration parameters to receive data of the MBS.

In some implementations, “MBS” can be replaced by “MBS session” or vice versa. In some implementations, “message” is used and can be replaced by “information element (IE)”. In some implementations, “IE” is used and can be replaced by “field”. In some implementations, “configuration” can be replaced by “configurations” or the configuration parameters.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method in a user equipment (UE) for activating reception of multicast and/or broadcast services (MBS), the method comprising:
operating in an inactive state of a protocol for controlling radio resources;
receiving, in the inactive state from a radio access network (RAN), a paging message including an MBS session identifier (ID); and
initiating reception of MBS data corresponding to the MBS session ID in response to the paging message, including:
performing one or more procedures to transition the UE to a connected state of the protocol, to receive MBS data in the connected state of the protocol, when the MBS session ID has a first value, and
receiving the MBS data in the inactive state of the protocol when the MBS session ID has a second value.

2. The method of claim 1, further comprising:
determining that the first value of the MBS session ID corresponds to a multicast session.

3. The method of claim 1, further comprising:
determining that the second value of the MBS session ID corresponds to a broadcast session.

4. (canceled)

5. (canceled)

6. The method of claim 1, wherein the MBS session ID includes a Temporary Mobile Group Identity (TMGI).

7. The method of claim 1, further comprising:
receiving, from the RAN, resource configuration for the MBS data via an MCCH.

8. (canceled)

9. The method of claim 1, wherein:
the paging message is a first paging message when the MBS session ID corresponds to a multicast session; and
the paging message is a second paging message when the MBS session ID corresponds to a broadcast session.

10-12. (canceled)

13. The method of claim 1, wherein the performing of the one or more procedures includes performing an RRC resume procedure.

14. The method of claim 1, wherein the performing of the one or more procedures includes performing a random access procedure.

15. A UE comprising processing hardware and configured to:
operate in an inactive state of a protocol for controlling radio resources;
receive, in the inactive state from a radio access network (RAN), a paging message including an MBS session identifier (ID); and
initiate reception of MBS data corresponding to the MBS session ID in response to the paging message, including:
perform one or more procedures to transition the UE to a connected state of the protocol, to receive MBS data in the connected state of the protocol, when the MBS session ID has a first value, and
receive the MBS data in the inactive state of the protocol when the MBS session ID has a second value.

16. The UE of claim 15, wherein:
the first value of the MBS session ID corresponds to a multicast session, and
the second value of the MBS session ID corresponds to a broadcast session.

17. The UE of claim 15, wherein the MBS session ID includes a Temporary Mobile Group Identity (TMGI).

18. The UE of claim 15, further configured to:
receive, from the RAN, resource configuration for the MBS data via an MCCH.

19. The UE of claim 15, wherein:
the paging message is a first paging message when the MBS session ID corresponds to a multicast session; and
the paging message is a second paging message when the MBS session ID corresponds to a broadcast session.

20. The UE of claim 15, wherein the performing of the one or more procedures includes performing an RRC resume procedure.

21. The UE of claim 15, wherein the performing of the one or more procedures includes performing a random access procedure.

22. A method in a user equipment (UE), the method comprising:
operating in an inactive state of a protocol for controlling radio resources;
receiving, in the inactive state from a radio access network (RAN), a paging message;
when the paging message is of a first type or is associated with a first type of a service, performing one or more procedures to transition the UE to a connected state of the protocol and to receive data in the connected state of the protocol; and
when the paging message is of a second type or is associated with a second type of a service, receiving the data in the inactive state of the protocol.

23. The method of claim 22, wherein:
the first type of the paging message is a radio access network (RAN) paging message;
the second type of the paging message is a core network (CN) paging message;

24. The method of claim 23, wherein:
the second type of the paging message is for an MBS service.

25. The method of claim 22, wherein:
the first type of service of the paging message is a unicast service;
the second type of service of the paging message is an MBS service;

26. The method of claim 22, wherein:
the data received in the connected state of the protocol is unicast data, and
the data received in the inactive state of the protocol is MBS data.
